(19) United States
(12) Patent Application Publication
(10) Pub. No.: US 2026/0012056 A1
(43) Pub. Date: Jan. 8, 2026

(54) Construction Machine And/Or Industrial Truck And Drive Unit For Same

(71) Applicant: Liebherr-Components Biberach GmbH, Biberach an der Riss (DE)

(72) Inventors: Mathias Blank, Satteins (AT); Viktor Schindler, Uttenweiler (DE); Norbert Hausladen, Biberach an der Riss (DE)

(21) Appl. No.: 18/993,435

(22) PCT Filed: Jun. 30, 2023
(86) PCT No.: PCT/EP2023/068048

§ 371 Date: Feb. 5, 2025

(30) Foreign Application Priority Data
Jul. 13, 2022 (DE) 10 2022 117 537.5

(51) Int. Cl. H02K 5/20; F16D 65/78; F16D 66/00; H02K 7/00; H02K 7/102; H02K 7/116; H02K 11/25; H02K 21/24

(52) U.S. Cl. CPC H02K 5/203; F16D 65/78; H02K 7/006; H02K 7/102; H02K 11/25; H02K 21/24; F16D 2065/783; F16D 2065/787; F16D 2066/001; H02K 7/116

(57) ABSTRACT

A drive unit for construction machines and/or industrial trucks having an electric motor, a transmission, a brake and a cooling device with at least one coolant circuit for cooling the electric motor and the brake. The electric motor and the brake have directly adjacent motor interior and brake chambers that border on a common end-side cooling flange which is cooled by an end-side cooling circuit section of the cooling device.

The present invention relates to a drive unit for construction machines and/or industrial trucks, such as cranes, with an electric motor, a transmission, a brake and a cooling device with at least one coolant circuit for cooling the electric motor and the brake. The invention also relates to construction machines and/or industrial trucks with such a drive unit.

In construction machines and/or industrial trucks such as cranes, cable excavators, diaphragm wall cutters or deep drilling machines or the like, for driving the functional or working units such as winches or drills there have often been used hydraulic drive units, wherein such drive units, in addition to the drive motor, also regularly have a transmission, for example in the form of a planetary gear, and a brake for braking and/or holding the working unit. While hydraulic motors can be cooled quite easily by the hydraulic flow, this is sometimes difficult with the brakes integrated into the drive units, but sometimes it is also not necessary. For example, currently, in most cases, in the hydraulically operated winches of cranes or cable excavators in use, the brake chamber or brake is not actively cooled. However, should brake cooling be required, then an oil circulation cooling system can be used, this, however, entails high drag losses due to the rotating brake discs. In construction machines and/or industrial trucks such as cranes, cable excavators, diaphragm wall cutters or deep drilling machines or the like, for driving the functional or working units such as winches or drills there have often been used hydraulic drive units, wherein such drive units, in addition to the drive motor, also regularly have a transmission, for example in the form of a planetary gear, and a brake for braking and/or holding the working unit. While hydraulic motors can be cooled quite easily by the hydraulic flow, this is sometimes difficult with the brakes integrated into the drive units, but sometimes it is also not necessary. For example, currently, in most cases, in the hydraulically operated winches of cranes or cable excavators in use, the brake chamber or brake is not actively cooled. However, should brake cooling be required, then an oil circulation cooling system can be used, this, however, entails high drag losses due to the rotating brake discs.

Recently, however, the drive units of the working units of such construction machines and/or industrial trucks have been electrified for various reasons, for example to utilize the better efficiency of electric motors and to simplify the control system. When using highly compact electric drives, which have a high-speed electric motor and at least one gear stage, the input speed is significantly higher than with classic hydraulic drives. As a result, the brake end speed is also significantly higher, which leads to even higher thermal losses in the brake chamber. In the case of multi-disc brakes in particular, the rotating brake discs only have a few tenths of a millimeter of clearance between them when the brake is released, meaning that the oil shear in the release gap generates a very high level of thermal energy. As the circumferential speed of the brake discs increases, the energy loss generated also increases, which creates a high thermal load, especially with high-speed electric motors. These losses should be dissipated as cost-effectively and efficiently as possible with the aid of a cooling system.

In this case, it is known from experience with overheated brakes that high-speed brakes that are easily immersed in an oil bath must always be viewed very critically with regard to their heat balance. In addition, classic recirculating oil cooling systems have considerable disadvantages with regard to high efficiency losses caused by the high circumferential speeds of the rotating brake discs and are only suitable for high-speed drives to a limited extent.

From the patent document DE 20 2019 101 918 U1 there is known a cooling apparatus for the drive unit of a tunnel boring machine, in which between two transmission sections or stages in order to better cool the transmission, which is typically very long in tunnel boring machines there is arranged a separate heat exchanger module in the form of an annular body. The ring-shaped heat exchanger module is passed through by a gear shaft, which couples planetary gear stages arranged on either side of the heat exchanger module.

From the DE 10 145 521 A1 there is further known a cooling system for an electric motor, wherein a hollow cylindrical heat exchanger is seated on the outer circumference of the stator. In this case, cooling channels guided through the heat exchanger have a circular internal cross-section so that the cooling channels can be kept clean during motor operation by cleaning balls carried in the cooling water and the motor cooling system can thus maintain its functionality.

Furthermore, in the patent document DE 10 2010 054 028 B4, there is shown a geared motor unit comprising several electric motors and a transmission as well as an adapter arranged therebetween, wherein coolant channels are configured in an adapter flange of the adapter in order to bring together the coolant flows from the several electric motors.

In contrast thereto, it is the object of the present invention to provide an improved drive unit of the type as well as an improved construction machine and/or industrial truck with such a drive unit, which avoid the disadvantages of the prior art and further develop the latter in an advantageous manner. In particular, efficient and sufficiently strong cooling of the electric motor and the brake is to be achieved in equal measure, without suffering excessive drag losses at high speeds and without incurring the risk of overheating.

According to the invention, the object is achieved by a drive unit according to claim 1 and a construction machine and/or industrial truck according to claim 20. Preferred embodiments of the invention are the subject-matter of the dependent claims.

It is therefore proposed to cool the brake and the electric motor from a common end-face where the electric motor and the brake border each other. Advantageously, the brake is attached directly to the interface with the electric motor in order to be able to cool the brake and electric motor together. According to the invention, the drive unit is characterized by the fact that the electric motor and the brake have directly adjacent motor interior and brake chambers, which border on a common end-face cooling flange, which is cooled by an end-face cooling circuit portion of the cooling apparatus. Due to the common cooling flange, which separates the brake chamber from the motor interior and extends transversely to the axis of rotation of the electric motor, the cooling apparatus can efficiently remove heat from both the motor interior chamber and the brake chamber, as the heat from both chambers can efficiently reach the end-face cooling circuit portion.

Thanks to the end-face cooling of the brake chamber and electric motor, thermal energy can also be dissipated from the brake chamber very easily and without additional design effort by increasing the flow rate of the cooling medium in the cooling circuit of the electric motor. This means that higher brake speeds can also be realized and thermally controlled very easily and efficiently.

In a further development of the invention, the brake chamber can border directly on the cooling flange without any further intermediate flange. In particular, the brake can be flanged directly to the end-face of the electric motor and the brake chamber can border on an end-face housing wall of the electric motor without any further intermediate flange. The end-face housing wall of the electric motor can form the cooling flange.

Advantageously, the common cooling flange for cooling the brake and the electric motor can separate the brake chamber and the motor interior chamber from each other in a fluid-tight or oil-tight manner or form a fluid-tight partition between the brake chamber and the motor interior chamber, which prevents overflowing of oil from the brake chamber into the motor. If the brake is arranged on the drive side of the motor, the cooling flange can be sealed to the motor shaft by means of a shaft sealing element.

Accordingly, the brake can have a brake housing that has an end-face in an open manner and is seated with the open end-face on the cooled end-face of the motor housing, so that the cooled end-wall of the motor housing can cool the brake chamber.

In principle, it would be possible for the electric motor and the brake to have a common housing that forms a unit as intended, in which the motor interior chamber and the brake chamber are configured separately from one another and an integral intermediate wall between the brake chamber and the motor interior chamber forms the cooling flange.

In an alternative further development of the invention, however, the electric motor on the one hand and the brake on the other hand can have separate housings and/or form separate, pre-assembled assemblies which can be placed end-face to end-face or can be mounted end-face to end-face on one another, so that the brake chamber borders directly on the motor interior chamber or the end wall portion of the motor housing.

The brake housing can, in this case, be part of the transmission housing in which the transmission is also accommodated or, together with the transmission housing, form a brake/transmission housing module in which the brake chamber accommodating the brake advantageously forms a separate, in particular also hydraulically separated, space. Depending on the arrangement of the brake, however, the brake can also have a separate brake housing and the transmission can also have a separate gear housing.

Advantageously, the drive unit can have a modular structure, wherein at least the electric motor on the one hand and the brake and the transmission on the other hand can each form an independent, pre-assembled assembly, which can be detachably mounted to one another in order to jointly form the drive unit. In an advantageous further development of the invention, the brake and the transmission can also each form independent, pre-assembled assemblies, so that in this case the electric motor and the brake and the transmission can each form an independent, pre-assembled assembly, all three of which can be mounted axially to one another.

Advantageously, in this case, the brake module and the transmission module can have end-face connection contours and/or end-face fastening means that correspond to each other, so that selectively the transmission module can be mounted directly without a brake on the end-face of the electric motor or selectively the transmission module can be mounted on one end-face of the brake module and the brake module can in turn be mounted with the other end-face on the end-face of the electric motor. In this way, the drive unit comprising the electric motor and an integrated transmission can be operated selectively with or without a brake.

In an advantageous further development of the invention, the brake can be arranged on the output side of the electric motor. In particular, the brake can be sandwiched between an end-face of the electric motor and the input side of the transmission, wherein the electric motor, the brake and the transmission can be arranged coaxially and/or axially one behind the other. In this case, the motor output shaft can extend through the brake into the transmission or extend as far as the transmission in order to be connected there in a torque-transmitting manner to a transmission input element. The brake elements, such as brake discs, can be seated coaxially on the motor output shaft, wherein the rotating brake discs can be rotationally connected to the output shaft and the stationary brake discs can be mounted rotationally stationary on the brake housing.

In an alternative further development of the invention, however, the brake can also be mounted on the B-side of the electric motor, i.e., on the end-face of the electric motor opposite the output shaft. In this case, the electric motor can be sandwiched between the transmission and the brake, wherein the brake, the electric motor and the transmission can also be arranged coaxially and/or axially one behind the other.

In order to be able to cool the brake even more, a further flange cooler can be assigned to the brake in addition to the cooling flange between the motor and brake, in particular on the end-face of the brake facing away from the motor. The flange cooler can advantageously extend transversely to the axis of rotation of the electric motor and/or the axis of rotation of the brake-similar to the cooling flange between the electric motor and the brake-so that the brake elements of the brake are arranged between the cooling flange and the flange cooler, for example in the form of the brake plates or the brake stator and brake rotor. This allows heat to be extracted from both end-faces of the brake.

The additional flange cooler can in principle be fed from a separate coolant circuit. In an alternative further development of the invention, however, the flange cooler and the cooling flange can be supplied with coolant from the same cooling circuit, wherein, for example, a flow divider or a diverter and/or a branch can be provided in the cooling circuit inlet to the cooling flange in order to divert cool coolant upstream of the cooling flange for the flange cooler. In principle, however, it would also be possible to allow the coolant to flow through the cooling flange and the flange cooler in series. However, a parallel or independent supply of coolant to the cooling flange and the flange cooler can have advantages in terms of strong cooling of the brake on both sides and better controllability of the cooling performance on the brake and electric motor.

In an advantageous further development of the invention, the cooling apparatus can have an individual control of the coolant quantities for the cooling flange between the electric motor and the brake chamber on the one hand and the flange cooler of the brake on the other hand, in order to be able to individually adjust the joint cooling capacity for the electric motor and brake on the one hand and the cooling capacity for the brake via the flange cooler on the other hand, in particular to set them larger or smaller independently of one another.

For example, the control device of the cooling apparatus may comprise a controllable or adjustable flow divider which supplies the quantity of coolant coming from a supply line in various adjustable ratios to the cooling flange on the one hand and to the flange cooler on the other.

Alternatively, or additionally, the control device for controlling the cooling capacity at the cooling flange and flange cooler can also comprise a pump with adjustable delivery rate, wherein, for example, a pump with adjustable pump speed can be used.

Such an adjustable pump can, if necessary, feed the cooling flange and the flange cooler, possibly in conjunction with the flow divider, in order to vary the overall coolant quantity and to be able to variably adjust the ratios of the coolant quantities reaching the flange cooler and the cooling flange.

Alternatively, or additionally, several pumps, preferably adjustable in terms of delivery rate, can also be used, one of which can feed the cooling flange and another of which can feed the flange cooler of the brake.

In this case, the control device of the cooling apparatus can advantageously cooperate with a temperature detection apparatus, which can detect at least one temperature and provide a corresponding temperature signal, for example a temperature of the cooling flange between the motor interior chamber and the brake chamber and/or a temperature of the oil bath of the brake and/or a temperature of the brake chamber and/or a temperature of the brake elements. Alternatively, or additionally, the detection apparatus can also detect a temperature of the electric motor and/or a temperature of the motor interior chamber and/or a temperature of the stator and/or the rotor of the electric motor.

Advantageously, the temperature detection device can comprise several temperature sensors that can detect at least one temperature at the electric motor on the one hand and at least one temperature at the brake on the other.

The control device can be configured to control and appropriately adjust the coolant quantity and/or the coolant distribution in dependence on the at least one temperature signal. In particular, in dependence on an engine temperature and/or in dependence on a brake temperature, the flow rate can be changed and adjusted via the flow divider and/or by varying the pump speed and/or the coolant supply temperature in order to adjust the cooling capacity of the cooling flange and/or the flange cooler to the detected temperatures, in particular to cool the cooling flange between the motor interior chamber and the brake interior chamber more strongly and/or to cool the flange cooler more strongly when the engine temperature and/or brake temperature rises.

If the temperatures increase differently, different strategies can also be used: If, for example, the engine temperature increases more than the brake temperature, the cooling apparatus control device can change the amount of coolant so that the cooling flange between the engine and brake is cooled more and the flange cooler is cooled less. If, on the other hand, the brake temperature increases more than the engine temperature, the flange cooler, for example, can be cooled more and the cooling temperature of the cooling flange between the engine and brake can be maintained.

In an advantageous further development of the invention, the electric motor can be configured as an axial flux machine. In such a radial flux motor, the magnetic flux between the stator and rotor runs substantially parallel to the axis of rotation of the motor, wherein the stator and rotor can be configured in the form of disks which are spaced apart from one another axially. Such an axial flux motor is not only characterized by a very flat and compact design as well as a high torque with low power consumption, but also brings advantages with regard to the proposed end-face cooling. In particular, the cooling flange between the motor interior chamber and the brake chamber can cool such an axial flux machine efficiently, as a large efficient cooling surface can be achieved.

In particular, the axial flux motor can be designed in a stator-rotor, stator-rotor-stator or stator-rotor-stator-rotor-stator configuration. These designs of the axial flux motor have the advantage that end-face plate coolers, in particular the aforementioned cooling flange between the brake chamber and motor interior chamber, can be used to cool the stators of the motor, as the contact surfaces or the opposing surfaces between the stator and plate cooler end face are very large.

If the axial flux machine is designed in a stator-rotor configuration, the brake is advantageously arranged on the end-face of the electric motor on the stator side.

The invention will be explained in more detail in the following with respect to preferred embodiments and to associated drawings. The drawings show:

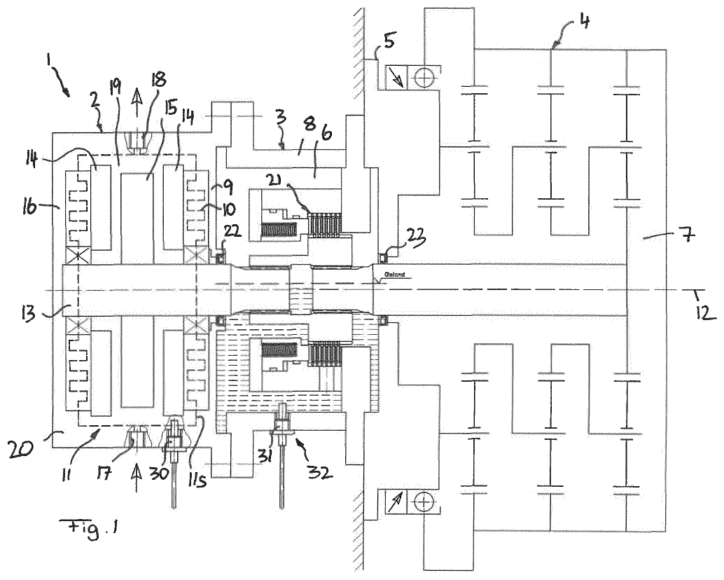

FIG. 1 a longitudinal sectional view of a drive unit according to an advantageous embodiment of the invention, in which a brake/transmission module with a brake chamber is flange-mounted directly to the output end-face of the electric motor, so that an end-face cooling flange of the electric motor borders directly on the brake chamber without any further intermediate flange;

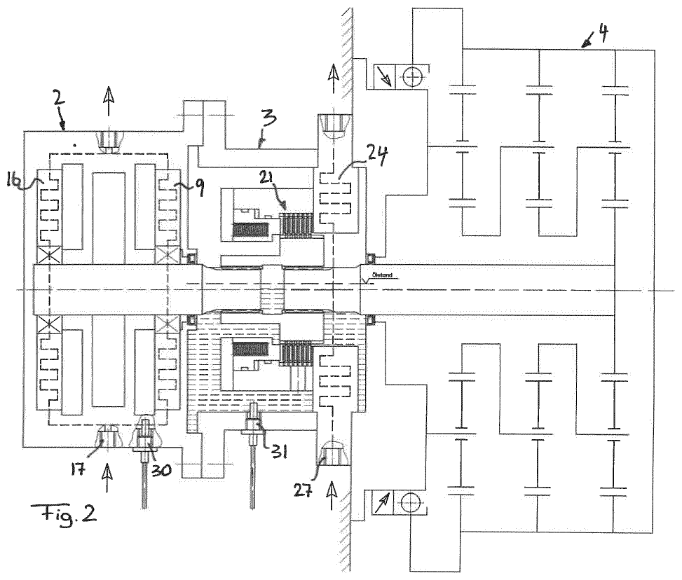

FIG. 2 a longitudinal section of a drive unit similar to FIG. 1 according to a further advantageous embodiment of the invention, according to which the brake comprises an additional flange cooler on its end-face facing away from the electric motor,

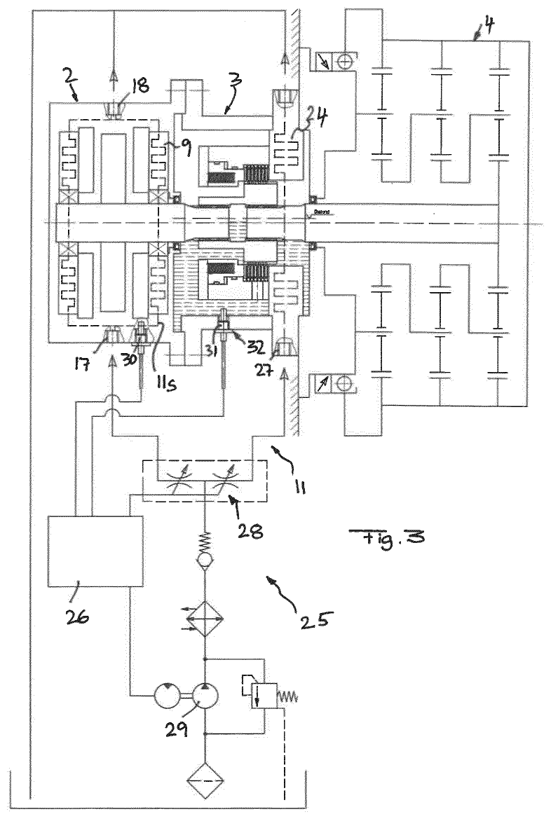

FIG. 3 a sectional view of the drive unit similar to FIG. 2, wherein the coolant supply system is also shown, which provides for flow regulation through the cooling flanges of the electric motor and the additional flange cooler of the brake;

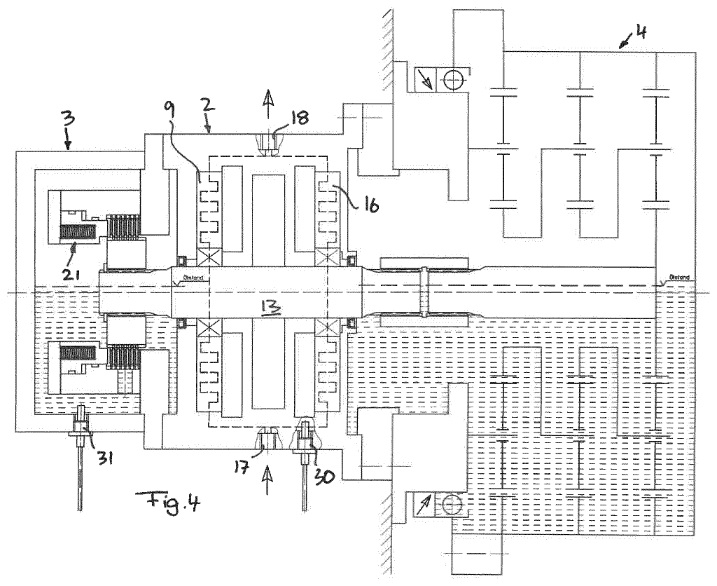

FIG. 4 a longitudinal section of a drive unit according to a further advantageous embodiment of the invention, according to which the brake is mounted on the end-face of the electric motor on the B side and the transmission is connected directly to the output side of the electric motor;

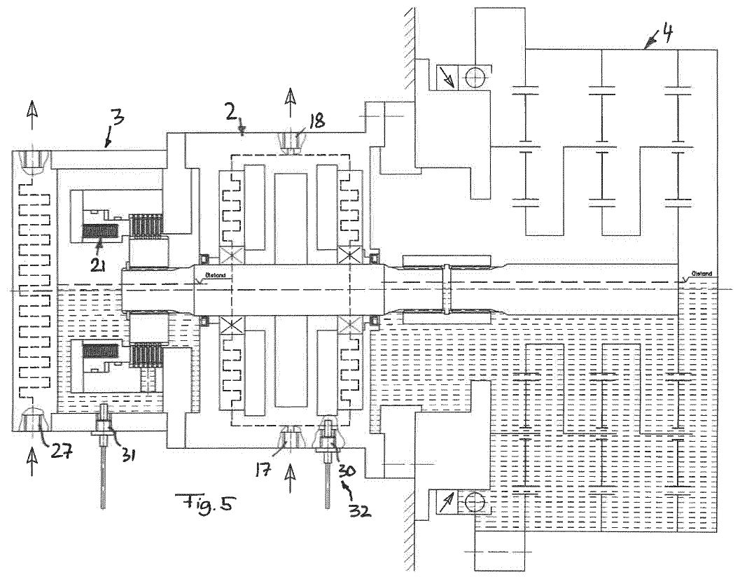

FIG. 5 a longitudinal section of a drive unit similar to FIG. 4, wherein the brake has an additional flange cooler on its end-face facing away from the electric motor; and

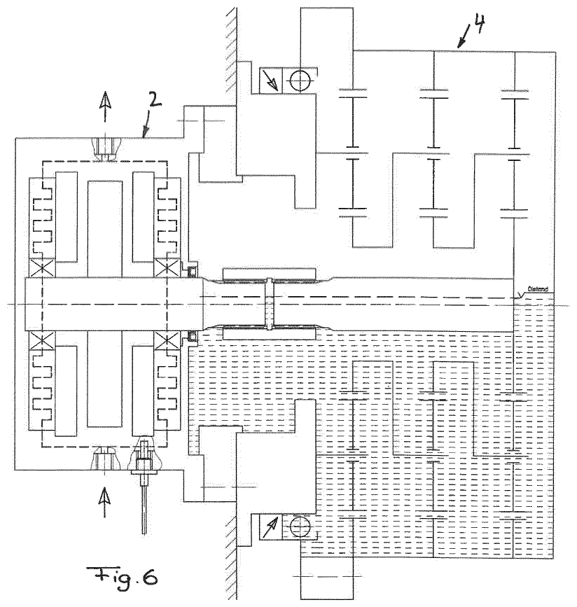

FIG. 6 a longitudinal section through the drive unit shown in FIGS. 1-3, wherein the transmission is mounted directly on the end-face of the electric motor without a brake.

As shown in the figures, the drive unit 1 comprises an electric motor 2, a brake 3 and a transmission 4, which can be arranged coaxially to one another and, in particular, mounted axially one behind the other. The components electric motor 2, brake 3 and transmission 4 can each form independent, pre-assembled assemblies, so that the drive unit 1 has an overall modular structure. In this case, the brake 3 and the transmission 4 may be combined to form a common assembly, which may comprise a common brake/gear housing 5, in which a brake chamber 6 for the brake 3 may be configured and advantageously separated and/or sealed from a transmission chamber 7 in order to allow different lubricant levels to be provided in the transmission chamber 7 and in the brake chamber 6, as will be explained.

Alternatively, however, the brake 3 and the transmission 4 can also comprise separate housings, in the form of a transmission housing 5 and a brake housing 8, which can be mounted end-face to end-face.

In this case, the brake 3 is mounted directly on an end-face interface of the electric motor 2, so that the brake chamber 6 borders directly on an end-face housing wall of the electric motor 2, cf. FIG. 1 to FIG. 3. In particular, the brake chamber 6 borders directly on the end-face housing wall of the electric motor 2 without an intermediate flange. In this case, the end-face housing wall of the electric motor 2 forms a cooling flange 9, through which one or more coolant channels 10 are passed in order to allow a coolant from a coolant circuit 11 to flow through the cooling flange 9 and cool the latter.

As shown in the figures, the electric motor 2 can advantageously be configured as an axial flux machine, wherein stator and rotor disks can be lined up axially one behind the other in the longitudinal direction 12 of the motor shaft 13 and the magnetic flux between stator and rotor is approximately parallel to the longitudinal direction 12. In particular, such an electric motor 2 configured as an axial flux machine can comprise at least two stators 14, between which at least one rotor 15 is sandwiched, which is rotationally fixedly connected to the motor shaft 13.

As the figures show, the stator-rotor package of the electric motor 2 can be surrounded on opposite end faces by two cooling flanges 9 and 16 in order to cool the rotor-stator package of the electric motor 2 from opposite end faces. In this case, the coolant can flow through the two cooling flanges 9 and 16 in series. In an alternative, advantageous further development of the invention, however, the two cooling flanges 9 and 16 can also be connected in parallel, so that a coolant inflow 17 is split upstream of the two cooling flanges 9, 16 in order to allow cool cooling fluid to flow equally through both cooling flanges 9, 16, which is then recombined at a coolant outflow 18, cf. FIGS. 1 to 6.

By coupling the brake chamber 6 to the end-face of the electric motor 2 without an intermediate flange, the cooling flange 9, which extends transversely to the longitudinal direction 12 of the motor shaft 13 at the end-face and can form the end-face housing wall of the motor housing, not only the motor interior chamber 19 of the motor housing 20 and the rotor-stator package arranged therein are cooled, but also the brake chamber 6 and the brake elements 21 arranged therein.

The brake 3 can have brake discs as brake elements 21 in particular, of which one set of brake discs can be fastened in rotation to the motor shaft 13 or a transmission input shaft connected thereto in rotation, while the second set of brake discs can be mounted in rotation to the brake housing 8. In this case, the brake plates 21 can be pressed axially onto one another or, conversely, axially released from one another in a manner known per se, wherein a pre-tensioning device, for example in the form of a spring, can be provided in a manner also known per se in order to pretension the brake plates 21 into the brakes of the engaged position. The brake can be released against the spring preload by means of a suitable actuator, for example in the form of a pressure medium cylinder or a magnetic actuator.

As shown in FIGS. 1 to 3, the cooling flange 9 separates the brake chamber 6 from the motor interior chamber 19, in particular in a hydraulically sealed manner, wherein a sealing element 22 can seal the cooling flange 9 with respect to the motor shaft 13. The sealing element 22 can be, in particular, the shaft sealing ring of the electric motor 2.

The brake chamber 6 can be sealed against the transmission chamber 7 by a further sealing element 23 on the end-face facing away from the electric motor 2, wherein the sealing element 23 can also be a shaft sealing ring, which can be seated on the motor or transmission input shaft and seals the latter against an end-face flange of the gear housing 5.

The oil-tight separation of the brake chamber 6 allows the brake 3 to be designed with a separate oil supply so that the oil level in the brake chamber 6 can be adjusted independently of the transmission oil level, thereby reducing drag losses due to the rotating brake discs. In particular, the oil level in the transmission chamber can be dimensioned differently than in the brake chamber. For example, the brake chamber 6 can be filled with oil to approximately half or up to the height level of the motor shaft, cf. FIG. 1.

In principle, the transmission 4 can be of different designs and comprise one or more gear stages. In order to achieve a sufficient reduction ratio for a high-speed electric motor, for example, the transmission 4 can be configured as a planetary gear and have several planetary stages. For example, the motor shaft or a transmission input shaft rotationally connected to it can drive a sun gear of a first planetary stage, to whose planet carrier the sun gear of a further planetary stage can be connected. Other connections of the planetary stages are just as possible as other designs of the gear stages, such as spur gear stages.

In order to be able to cool the brake 3 more strongly, in addition to the cooling flange 9 between the brake 3 and electric motor 2, a further cooling element or heat exchanger element can be provided for cooling the brake 3, which can be configured in the shape of a flange cooler 24, for example, which can be arranged on the end-face of the brake chamber 6 facing away from the electric motor 2, cf. FIG. 2.

By providing such an additional flange cooler 24 on the end-face of the brake 3 facing away from the electric motor 2, heat can be extracted from the brake 3 on opposite end-faces. In particular, the braking elements 21, which can be sandwiched between the cooling flange 9 and the flange cooler 24, can be cooled from opposite end-faces.

In an advantageous further development of the invention, the stationary brake element, for example in the form of the stationary brake disk pack, can be mounted on the flange cooler 24 with a sufficiently large contact surface in order to efficiently introduce heat from the stationary brake disk pack into the flange cooler 24. Alternatively, or additionally, the flange cooler 24 can also be immersed in the oil bath of the brake 3 in order to cool the oil bath.

The cooling apparatus 25 for cooling the brake 3 and the electric motor 2 may advantageously comprise a control device 26 for variably adjusting the flow rate and/or the coolant flow temperature, wherein the control device 26 may comprise a controller for controlling the flow rate and/or the flow temperature.

As shown in the figures, a temperature detection device 32 may be provided which can detect at least one temperature of the drive unit 1, for example a temperature of the electric motor 2 and/or a temperature of the brakes 3.

Advantageously, the temperature detection device 32 comprises at least two temperature sensors 30, 31, which measure the temperature of the electric motor 2 on the one hand and the temperature of the brake 3 on the other. For example, the temperature sensor 30 can detect the temperature in the motor interior chamber 19. The other temperature sensor 31 can, for example, measure the temperature in the brake chamber 6 and/or the temperature of the oil bath of the brake 3.

The control device 26 is advantageously configured for controlling or regulating the flow rate and/or the flow temperature in dependence on the temperature signal from the temperature detection device 32, in particular in dependence on the temperature signals from the two temperature sensors 30, 31.

As shown in FIG. 3, the control device 26 can, in dependence on the detected temperature (EN), control a pump 29 that is controllable with respect to the delivery rate in order to increase or decrease the flow rate, depending on whether the detected temperatures are above a threshold value or below a possibly same or different threshold value.

Alternatively, or additionally, the control device 26 can control a controllable flow divider 28 in dependence on the detected temperature (EN) in order to change the flow ratio which, on the one hand, describes the coolant quantity flowing into the electric motor 2 or the cooling flange 9 and, on the other hand, describes the coolant quantity flowing into the additional flange cooler 24 or defines the ratio of these two coolant quantities. As shown in FIG. 3, the flow divider 28 divides the total coolant quantity coming from the pump 29 into two partial flows, one of which is directed into the coolant inlet 17, which feeds the cooling flange 9 between the electric motor 2 and the brake 3, while the other partial flow is directed to a coolant inlet 27, which feeds the additional flange cooler 24.

As illustrated in FIG. 3, the cooling flange 9 of the electric motor 2 and the additional flange cooler 24 of the brake 3 are connected in parallel so that cool cooling fluid flows through them in equal measure. On the outlet side, the heated partial coolant flows are recombined and returned to the system tank.

As shown in FIG. 4, the brake 3 can also be mounted on the B-side of the electric motor 2, wherein the brake 3 can also be flanged to the end-face of the electric motor 2 with its brake housing 8. In particular, the brake 3 can be mounted on the B-side of the electric motor 2 in such a way that the end-face cooling flange 16 of the electric motor 2 borders directly on the brake chamber 6 without any further intermediate flange in order to cool the brake chamber 6 from the end-face of the electric motor 2.

Also, if the brake 3 is mounted on the B-side of the electric motor 2, an additional flange cooler 24 can be assigned to the brake 3, which can be mounted on the side facing away from the electric motor 2, cf. FIG. 5. Advantageously, the flange cooler 24 can also be connected in parallel to the cooling flange 9, 16 of the electric motor 2 and fed in the described manner via the flow divider 26 and the pump 25, which can be controlled by the delivery rate, in order to be able to adjust the cooling capacities in the area of the brake 3 and in the area of the electric motor 2 in the required manner.

As shown in FIG. 6, the modular design of the drive unit 1 also allows a configuration without a brake, wherein the transmission 4 can be mounted directly on the end-face of the electric motor 2, for example by means of a flange connection of the motor and gear housing 20, 5, cf. FIG. 6.

1. A drive unit comprising:
a common end-face housing wall separating a directly adjacent motor interior chamber of an electric motor and a brake chamber of a brake; and
an end-face cooling circuit portion of a cooling device configured to cool the common end-face housing wall.

2. The drive unit according to claim 1 further comprising:
a brake; and
an electric motor comprising the common end-face housing wall;
wherein:
the brake is flanged directly to the electric motor at the end-face housing wall;
the brake chamber borders directly on the end-face housing wall of the electric motor without any further intermediate flange; and
the end-face housing wall of the electric motor forms a cooling flange.

3. The drive unit according to claim 2, wherein the brake chamber and a brake housing surrounding the brake chamber is configured in an open manner at one end-face and is closed by a motor housing of the electric motor.

4. The drive unit according to claim 2, wherein the cooling flange separates the brake chamber and the motor interior chamber from each other in an oil-tight manner and forms an oil-tight partition that prevents oil overflowing from the brake chamber into the motor interior chamber.

5. The drive unit according to claim 4 further comprising a sealing element;
wherein the sealing element is positioned between the cooling flange and a motor shaft of the electric motor.

6. The drive unit according to claim 2 further comprising a transmission;
wherein:
the brake is seated on a drive side of the electric motor and is sandwiched between the electric motor and the transmission; and
the brake comprises brake elements arranged coaxially to the motor shaft and/or a transmission input shaft rotationally connected to the motor shaft, through which the motor shaft and/or the transmission input shaft extends.

7. The drive unit according to claim 2 further comprising a transmission;
wherein:
the brake is arranged on a B-side of the electric motor; and
the electric motor is sandwiched between the brake and the transmission.

8. The drive unit according to claim 2 further comprising a transmission;
wherein:
the drive unit has a modular structure;
the electric motor is a pre-assembled assembly;
the brake and the transmission form a pre-assembled assembly; and
the pre-assembled assemblies are configured to be detachably fastened to one another.

9. The drive unit according to claim 2 further comprising a transmission;
wherein:
the transmission has a transmission chamber that is separated in an oil-tight manner from the brake chamber of the brake; and
the brake and the transmission have separate oil supplies.

10. A drive unit comprising:
an electric motor;
a transmission;
a brake;
a cooling device for cooling the electric motor and the brake;
a common end-face cooling flange; and
a flange cooler that is arranged on an end-face of the brake facing away from the electric motor;
wherein:
the electric motor and the brake have directly adjacent chambers;
one of the chambers is a motor interior chamber of the electric motor;
another of the chambers is a brake chamber;
the motor interior and brake chambers border the common end-face cooling flange; and
the common end-face cooling flange is cooled by an end-face cooling circuit portion of the cooling device.

11. The drive unit according to claim 10, wherein:
the flange cooler and the cooling flange can be loaded with coolant from separate cooling circuits of the cooling device; or
the flange cooler and the cooling flange are connected in parallel to one another, and can be loaded with coolant from a single common cooling circuit of the cooling device.

12. The drive unit according to claim 11, wherein:
the cooling device comprises a control device; and
the control device for at least one of:
changing a coolant quantity ratio of a coolant quantity flowing through the flange cooler and the coolant quantity flowing through the cooling flange; or
individually adjusting the coolant quantities flowing through the flange cooler and the cooling flange independently of each other.

13. The drive unit according to claim 12, wherein:
the control device comprises a flow divider for dividing a flow of the coolant into a partial quantity feeding the flange cooler and a partial quantity feeding the cooling flange; and
the flow divider is configured to be adjustable with respect to the division ratio.

14. The drive unit according to claim 11, wherein the cooling device comprises a pump adjustable with respect to a delivery rate of the coolant.

15. The drive unit according to claim 11, wherein at least one of:
the cooling device has a temperature detection device for detecting a temperature of the electric motor
the cooling device has a temperature detection device for detecting a temperature of the brake; or
the control device is configured to control one or more of a coolant flow temperature, a coolant flow rate, or a coolant flow rate ratio in dependence on a temperature signal of a temperature detection device of the cooling device.

16. The drive unit according to claim 15, wherein:
the temperature detection device has at least one temperature sensor for detecting a temperature of the electric motor;
the temperature detection device has at least one temperature sensor for detecting a temperature of the brake; and
the control device has a controller for controlling one or more of the coolant flow temperature, the coolant flow rate, or the coolant flow rate ratio in dependence on the detected temperatures of the electric motor and the brake.

17. The drive unit according to claim 10, wherein the electric motor is configured as an axial flux machine.

18. The drive unit according to claim 17, wherein:
the axial flux machine has a stator-rotor configuration; and
the cooling flange is arranged on a stator side of the axial flux machine.

19. The drive unit according to claim 17 further comprising an additional cooling flange:
wherein:
the axial flux machine is a stator-rotor package that has a stator-rotor-stator or a stator-rotor-stator-rotor-stator configuration; and
the cooling flange and the additional cooling flange are provided, one each, on opposite end faces of the stator-rotor package.

20. A construction machine and/or industrial truck comprising the drive unit configured according to claim 1.

21. The drive unit according to claim 5, wherein the sealing element is in the form of a shaft sealing ring, the shaft sealing ring sealing the cooling flange with respect to the motor shaft.

22. The drive unit according to 2 further comprising a transmission;
wherein:
the drive unit has a modular structure;
the electric motor is a pre-assembled assembly;
the brake is a pre-assembled assembly;
the transmission is a pre-assembled assembly; and
the pre-assembled assemblies are configured to be detachably fastened to one another.
